(19) United States
(12) Patent Application Publication
(10) Pub. No.: US 2026/0273565 A1
(43) Pub. Date: Sep. 17, 2026

(54) APPARATUS AND METHOD FOR LIQUID APPLICATION TO A SHEET MATERIAL

(71) Applicant: Philip Morris Products S.A., Neuchatel (CH)

(72) Inventors: Rolando CAVICCHIOLI, Milano (IT); Ugo FRANCIOSO, Milano (IT)

(73) Assignee: Philip Morris Products S.A., Neuchatel (CH)

(21) Appl. No.: 19/163,876

(22) PCT Filed: Mar. 8, 2024
(86) PCT No.: PCT/EP2024/056283

§ 371 Date: Sep. 10, 2025

(30) Foreign Application Priority Data
Mar. 16, 2023 (EP) 23162248

(51) Int. Cl. B05B 14/30; A24B 15/38

(52) U.S. Cl. CPC B05B 14/30; A24B 15/385

(57) ABSTRACT

An apparatus for liquid application to a sheet material is provided, the apparatus including: a nozzle configured to spray a liquid on a sheet material arrangeable below the nozzle; and a concave shield arranged around the nozzle, the concave shield including a collection channel provided at an inner periphery of the shield, the collection channel being arranged to run circumferentially along the inner periphery of the concave shield, and at least one drain hole being arranged in the collection channel and configured to drain collected liquid from the collection channel.

The present disclosure relates to an apparatus and method for liquid application to a sheet material. More specifically, the invention relates to an apparatus and method for liquid application to a sheet material and collecting sprayed liquid.

In particular, for consumables in the smoking industries, sheet material is treated with a flavour before said sheet material is used in the consumable. A spraying process is typically performed in a chamber to limit contamination of nearby machinery and personnel. Irregular application of liquid to the sheet material is undesired as this may lead to inconsistent products and discoloration of outer materials of the consumable. Liquid application under high pressure seems to have good effects on uniformity of a spray pattern. However, spraying under high pressure likely causes formation of very small droplets, leading to an increased diffusion contaminating the environment. This is unfavourable in view of surrounding machine parts and personnel, as well as in view of an increased amount of liquid waste.

There is need for an apparatus and method for liquid application to sheet material limiting or eliminating above-mentioned disadvantages of prior art liquid application apparatus and methods. In particular, there is need for an apparatus and method for liquid application to a sheet material reducing effects of sprayed liquid to the environment.

According to an aspect of the present invention, there is provided an apparatus for liquid application to a sheet material. Preferably, the apparatus is an apparatus as may be used in the tobacco industries. The apparatus comprises a nozzle for spraying a liquid on a sheet material arrangeable below the nozzle. The apparatus also comprises a concave shield arranged around the nozzle, wherein the concave shield comprises a collection channel provided at an inner periphery of the shield. The collection channel is provided for collecting liquid accumulating at inner side walls of the concave shield and sliding down the inner side walls. At least one drain hole is arranged in the collection channel for draining collected liquid from the collection channel.

The provision of a concave shield around the nozzle prevents liquid droplets generated by the nozzle of for example an aerosolizer, a nebulizer or similar, from being directed to the sheet material or dispersed into the air and not arriving at the sheet material, so that the generated liquid droplets may get trapped on an inside of the concave shield. Thus, the trapped liquid accumulates at the inside of the concave shield and eventually flows down along the inside of the concave shield. The collection channel provided at the inner periphery collects the liquid, and the liquid is drained from the collection channel via one or more drain holes. Thus, diffused liquid not arriving at the sheet material is not further distributed to the environment, for example to chamber walls of a chamber where the liquid application process takes place. Potential contamination of other machine parts or clogging of, for example, a filtration system, may be prevented or reduced. In addition, an overflow of the collection channel may be prevented and collected liquid may be reused in the liquid application system, such that waste of liquid is reduced.

It has been found that with the provision of an apparatus as described herein, a waste reduction of 50% or even more may be achieved. In addition, due to a reduced amount of liquid contaminating machine parts in a liquid application apparatus but also of neighbouring machine parts, downtime of the system may be reduced, additionally saving time and cost. In particular, downtime of a liquid application apparatus often leads to crystallization of the liquid and thus to a clogging of a nozzle, additionally leading to material waste and increased maintenance need of the apparatus. Moreover, liquid may condense on chamber walls and form large droplets that possibly fall onto the sheet material due to gravitational force. These liquid spots may lead to discoloration of materials coming into contact with the sheet material and may lead to inconsistency of the products manufactured from the sheet material. While discoloration is a visual quality problem, crystallization and droplet formation may jeopardize correct and uniform liquid deposition. For example, when a liquid is a flavour, in particular menthol, these effects are known to cause problems in liquid application. Due to liquid trapping and collection of diffused liquid in a controlled manner these undesired effects may be reduced or prevented. In particular, in the apparatus according to the invention above mentioned adverse effects may be reduced also when using nebulizers having a wide spray distribution and being operated under elevated pressure forming highly volatile droplets. These kinds of nebulizers are preferably used due to their ability to create uniform spraying distribution. In addition, a concave shield including collection channel is a simple element and may be manufactured at low cost. Existing liquid application equipment may be provided with a concave shield or a shielding device as described further below in the application without major changes required at the existing application equipment.

The concavity of the concave shield supports a flow guidance of trapped and accumulated liquid downwards or sideways and downwards to the periphery of the concave shield and into the collection channel arranged at the periphery.

Preferably, a collection channel is arranged along the entire inner periphery of the shield. By this, liquid may be collected along the entire periphery of the concave shield. Most preferably, the collection channel is arranged to run circumferentially along the inner periphery of the concave shield.

A collection channel may be a separate channel element attached to one or more parts forming the walls of the concave shield. Preferably, the collection channel is an integral part of the concave shield, most preferably formed by shield portions.

Preferably, the collection channel is formed by inwardly bent peripheral sections of the shield.

In order for efficient liquid collection, liquid is guided in the collection channel to the at least one drain hole. Preferably, this is done using gravitational force and by positioning the at least one drain hole at a lowest lying portion in the collection channel.

This may be achieved by arranging the collection channel around the nozzle in a tilted manner. The concave shield may be provided around the nozzle in a tilted manner such that the at least one drain hole is arranged at a lowest position when the shield is mounted around the nozzle. Alternatively, or in addition, the collection channel itself may be arranged in a tilted manner in the concave shield. Preferably, a collection channel runs along a periphery, in particular along a circumference, of the concave shield in a tilted manner.

Preferably, the collection channel is arranged around the nozzle in a tilted manner such that the shield has a lowest portion, wherein the at least one drain hole is arranged in the lowest portion.

A drain conduit may be provided at the at least one drain hole. Via a drain conduit, liquid collected in the collection channel and guided to the drain hole may be led away from the concave shield, for example into a liquid recycling system. A drain conduit protects collected liquid from environmental contamination and may supply the collected liquid to a location remote from the concave shield.

The apparatus may, for example, comprise a collection reservoir arranged distant from the shield and such to accommodate liquid collected in and drained from the collection channel. Preferably, a drain conduit provided at the at least one drain hole runs from the at least one drain hole to a collection reservoir. In a collection reservoir larger amount of collected liquid may be stored, possible also prepared for a further reuse of the liquid.

The collection channel may comprise more than one drain hole. More than one drain hole may be advantageous in case of large amount of collected liquid to be drained from the collection channel. An overflow of the collection channel at undesired locations may thus be limited or prevented. In addition, more than one drain hole in the collection channel may possibly make up for a clogged or blocked drain hole.

If more than one drain hole is provided in the collection channel, a drain conduit may be provided at each of the more than one drain hole. Several collection reservoirs may be provided, for example, one for each drain conduit. Preferably, several drain conduits lead into one collection reservoir. Preferably, all drain conduits run from the more than one drain hole to one collection reservoir.

In preferred embodiments, the concave shield has a round circumference, for example is circular or elliptic. A circular concave shield provides a symmetric shielding of liquid droplets around a nozzle. Since typically nozzles are used that spray a liquid in a rotational symmetric manner onto a sheet material, rotationally symmetric concave shields to shield the nozzle are preferred.

However, the concave shield may also have other perimeters, for example, a rectangular perimeter. As the sheet material is generally and preferably provided as a band material guided below the nozzle and through the apparatus, a shield may also have a rectangular configuration. A certain symmetry of the shield may also be achieved with a rectangular shape, for example by a concave shield having a square shape.

A concave shield forms a cavity within the shield, wherein the cavity is closed at one side by a top of the shield and a nozzle arranged in an opening provided in the top of the shield. The concave shield is open opposite the top of the shield and accordingly, the cavity is open at its opposite end.

The concavity of the shield may be continuous or non-continuous. In particular, the concave shield may comprise a top wall and side walls. Typically, an interface between top wall and side walls is not continuous. Preferably, the concave shield comprises one or more than one continuous side walls. An interface between side walls may be non-continuous.

The concave shield may, for example, include a dome shape. A dome shape provides inner surfaces for an efficient liquid trapping and downward guidance to a collection channel. A dome shape may be provided in circular and elliptic but also in, for example, rectangular shaped concave shields.

Preferably, the concave shield is bell-shaped. Preferably, bell-shaped shields have a circular circumference. Preferably, bell-shaped shields comprise one continuous wall forming the concave shield or at least forming an entire side wall of the concave shield.

Bell-shaped shields have provided very good results in liquid trapping and collection. Experiments have shown, that in an apparatus for liquid application to a sheet material, waste of liquid may significantly be reduced, for example from 1.6 percent liquid waste from applications without a bell-shaped concave shield to 0.7 percent in applications with bell-shaped concave shield.

Preferably, the concave shield comprises curved wall portions. Curved wall portions allow a continuous and smooth guiding of liquid on the curved wall portions as well as a deflection of accumulated liquid on the curved wall portions. The concave shield may exclusively comprise curved wall portions.

Alternatively, or in addition, the concave shield may comprise flat wall portions. The concave shield may exclusively comprise flat wall portions. Flat wall portions are easy to manufacture and may be advantageous in, for example, mounting the concave shield to a nozzle.

A flat wall portion preferably forms a top wall of the concave shield. Preferably, the top wall is arranged horizontally in a mounted state of the concave shield.

A flat wall portion may form a lower side wall of the concave shield. In particular, a flat wall portion or flat wall portions may form a lowest side wall of the concave shield or a most peripherally arranged side wall of the concave shield.

A flat wall portion is herein understood as flat with respect to at least one direction, in particular in one direction only. A flat wall portion may, for example, be flat in an exact vertical or top-down direction of the concave shield in a mounted state of the shield. A flat wall portion may in particular be flat in a first direction and curved in a second direction perpendicular to the first direction, for example when the flat wall portion forms a side wall of the concave shield.

A flat wall portion is flat in a cross-sectional view of the concave shield. Preferably, a flat wall portion forming a side wall is straight in a vertical direction or directs straight radially outward and downward in a cross-sectional view of the concave shield. For example, a concave shield may have a substantially triangular cross-sectional shape. Therein, the side walls of the shield represent sides of the triangle.

Lower side walls of a concave shield are generally more bent or direct in a more vertical direction than upper side walls of a concave shield. For example, a lower side wall of the concave shield may be arranged at an angle between 40 degree and 90 degree, wherein 90 degree corresponds to the vertical in a mounted state of the shield. Preferably, a lower side wall may be arranged at an angle between 45 degree and 90 degree, wherein 90 degree corresponds to the vertical in a mounted state of the shield.

In general, wall portions of the concave shield preferably comprise a slant angle between 4 degree and 90 degree, preferably between 6 degree and 50 degree, for example 7 degree or 45 degree, wherein 90 degree corresponds to the vertical in a mounted state of the shield. Thus, a slant angle is measured between the horizontal and the vertical.

Preferably, a majority of wall portions of the concave shield comprise a slant angle of at least 30 degree.

In embodiments of a flat concave shield, a majority of wall portions are flat and comprise a slant angle of, for example, between 5 degree and 10 degree.

Slant angles in the above given ranges have shown to provide shapes of concave shields providing good results in view of liquid collection and in particular in view of good liquid guidance to a collection channel without formation of large droplets and an untimely fall-off of the droplets before the droplets have reached the collection channel. These shapes have also provided good results in trapping diffused liquid droplets but not interfering with droplet trajectories for droplets that are directed to the sheet material.

Preferably, an inside of the concave shield is continuous, preferably continuously curved. A continuous inner side wall of the concave shield supports a smooth and safe guidance of liquid to the collection channel. Continuity may prevent accumulation of liquid at discontinuities of an inner side of the concave shield that may potentially lead to the formation and fall-off of large droplets.

A size of the concave shield is preferably adapted to an area to be sprayed by a nozzle and the size of a sheet material where liquid shall be applied upon. A size of a concave shield is preferably such that an outer lateral extension of the concave shield is larger than a width of a sheet material to be provided with liquid. By this, the concave shield does not interfere with a lateral extension of a spray area of the nozzle.

A concave shield shall trap diffused liquid droplets, in particular light, volatile droplets, that have drifted away from a spray direction and that will most certainly not reach a sheet material. However, a concave shield shall possibly not trap liquid droplets, in particular heavy droplets, that will generally reach the sheet material.

A size of the concave shield may also be such that the collection channel arranged at the periphery of the concave shield is arranged at least partly outside of the sheet material. Thus, a drain hole may be arranged laterally outside of the sheet material. By this, liquid draining from the drain hole does not, also not inadvertently, get onto the sheet material and a drain conduit optionally provided at the drain hole does not interfere with the transport of the sheet material through the apparatus.

The concave shield may have a maximum lateral extension, preferably a diameter, between 0.10 meter and 1 meter. Preferably, the concave shield has a maximum lateral extension, preferably a diameter, between 0.15 meter and 0.7 meter, more preferably between 0.2 meter and 0.5 meter.

Concave shields with maximum lateral extensions in the above size ranges have provided good results in shielding and collecting sprayed liquid for sheet materials used in the tobacco industries, in particular in the manufacture of smoking articles or heat-not-burn articles, where an aerosol-forming substrate, for example a tobacco or nicotine containing substrate is heated rather than combusted.

The apparatus may further comprise a temperature control system adapted to control a temperature of sprayed liquid. Preferably, the temperature of the liquid is controlled in an indirect manner, for example, by a temperature control system that is adapted to control a temperature of at least any one of concave shield, in particular collection channel, drain conduit(s) if provided and collection reservoir if provided.

Temperature control of the liquid may support continuous flow of liquid and thus support the liquid application process, but in particular also the trapping and collection of liquid.

A temperature control may in particular prevent crystallization of liquid and thus loss of liquid or contamination or clogging of machine parts, for example of a drain channel, a drain hole or a drain conduit but also filtration systems or a nozzle.

In some embodiments, a temperature control system is adapted for controlling sprayed liquid only, preferably independent of a temperature of the liquid in the nozzle. Spraying results may depend on the kind of liquid to be sprayed, in particular its viscosity, such that a temperature control of the sprayed liquid does preferably not interfere with the spray process as such.

However, a temperature control system may be adapted to control a temperature of the nozzle. Since generation of crystals in a nozzle may lower a nebulizer spray efficiency, by controlling the temperature of the nozzle, crystallization of liquid in the nozzle may be prevented or limited and thus also inhomogeneous distribution of liquid on the sheet material and in particular downtime of the system. For example, heat radiation of a heated concave shield may be directed to a nozzle to heat the nozzle.

A temperature control system preferably comprises a heater and a temperature sensor. A heater may, for example, be a resistance heating element. The temperature control system may comprise a feedback loop connected to the temperature sensor for controlling the heater.

A temperature control system may comprise a cooling element, preferably for cooling the concave shield. By cooling the concave shield or parts of the concave shield, trapping of liquid on cooled shield walls and crystallization of the liquid on the walls may be enhanced. A subsequent heating of the respective shield walls may liquefy the trapped and crystallized liquid again, which may then be guided to the collection channel. A cooling element may, for example, comprise a thermoelectric element.

The temperature control system may be adapted to perform heating and cooling cycles. For example, a cooling period of a cycle may increase a trapping of liquid with the concave shield. A subsequent, preferably short, heating period of the cycle will melt trapped droplets and support a collection of liquid.

The apparatus may further comprise vibration means for vibrating at least parts of the concave shield. For example, by vibrating side walls of the concave shield, crystallization of trapped liquid may be limited or prevented, flow of trapped liquid may be supported, while gravitational force and the orientation of the side walls of the concave shield direct the trapped liquid into the direction of the periphery of the shield and into the collection channel.

Vibrations means may be provided and adapted to be more effective versus a periphery of the concave shield than to the top of the concave shield.

When providing vibration means, the concave shield and the nozzle may be mechanically disconnected in order for the nozzle and the sprayed liquid to not be affected by the vibration means.

Alternatively, vibration means may be directed to the nozzle to prevent or reduce crystallization of liquid in the nozzle. For example, sound vibrations of a vibrated concave shield may be directed to a nozzle in order to prevent or reduce crystallization in the nozzle.

To further keep collected liquid in the liquid form, a collection reservoir may comprise a stirring mechanism. Continuous movement of the liquid may prevent crystallization and may keep the liquid homogeneous. Alternatively, or in addition, a collection reservoir may comprise a heater for heating the collection reservoir or liquid collected in the collection reservoir.

The apparatus may further comprise a transport device adapted for transporting a sheet material past the nozzle with the concave shield. The transport device may comprise at least one roller rotatable in a transport direction. The roller is adapted for supporting a sheet material to be transported in the transport direction and for passing the apparatus below the nozzle.

Liquid is applied to the sheet material while the sheet material passes the nozzle. A sheet material may be transported through the apparatus continuously or step-wise. Preferably, a sheet material is transported through the apparatus continuously and preferably at a constant speed. In a continuous liquid application process, the sheet material may be provided with a homogeneous, consistent amount of liquid over an entire surface area of the sheet material. This allows the manufacture of products from the sheet material having consistent and reproduceable results. In addition, a continuous operation of a spray nozzle is advantageous, as crystallization of liquid in the nozzle and thereby clogging of the nozzle may be reduced or prevented.

Preferably, the nozzle is a nozzle of a nebulizer.

More than one nozzle may be used. The more than one nozzle is preferably arranged in series or in an array, preferably a regular array.

The apparatus may further comprise a housing covering the apparatus. The housing keeps the liquid application process protected. In addition, a housing may prevent further environment from being contaminated with sprayed liquid and the spraying process from being affected by environmental influences such as, for example, dirt or draught.

According to another aspect of the present invention, there is provided a method for liquid application to a sheet material, the method comprising:
providing a sheet material and a nozzle for liquid application;
transporting the sheet material past the nozzle, thereby applying liquid to the sheet material by the nozzle;
trapping liquid not applied to the sheet material with a concave shield arranged around the nozzle, in particular the liquid that is sprayed by the nozzle but deflected or otherwise diffused to the environment;
letting trapped liquid accumulate and flow along inner side walls of the concave shield, wherein preferably use is made of gravitational force to let the liquid flow downwards;
collecting trapped liquid in a collection channel provided at an inner periphery of the concave shield; and
draining collected liquid from the collection channel through at least one drain hole arranged in the collection channel.

Preferably, the method comprises collecting liquid along an entire inner periphery of the shield. For maximum waste recovery, preferably maximum areas of the concave shield are used to trap, accumulate and collect liquid that is sprayed but not applied to the sheet material.

Preferably, the method comprises designing the collection channel in a tilted manner for the collection channel to have a lowest portion and arranging the at least one drain hole in the lowest portion. This allows to let an amount of liquid collected in the entire collection channel to be guided to the at least one drain hole and let this entire amount of liquid drain at a central point from the at least one drain hole.

Preferably, the method comprises further draining collected liquid through a drain conduit and into a collection reservoir. Drain conduit and collection reservoir allow for a centralized collection of liquid.

The method may comprise draining collected liquid from the collection channel through more than one drain hole.

Preferably, the method comprises letting trapped liquid flow along continuously formed side walls of the concave shield.

The method may comprise controlling a temperature of the liquid to control evaporation or crystallization of trapped or collected liquid. These measures may enhance waste recovery and reduce maintenance frequency of the apparatus.

Preferably, the method comprises heating liquid trapped or collected by the concave shield. In particular, this may include heating liquid on shield side walls, in the collection channel, in a drain conduit if provided or in a collection reservoir if provided. By heating trapped or collected liquid, crystallization of the liquid and by this contamination or clogging of machine parts may be limited or prevented.

The controlling a temperature of the liquid may also comprise cooling the concave shield, in particular side walls of the concave shield. By colling of apparatus parts, in particular of the concave shield a trapping of liquid droplets may be enhanced at specific locations intended and desired for liquid trapping.

To support a moving of liquid trapped at the concave shield into the direction of the collection channel, the method may comprise vibrating the concave shield.

The method may also comprise moving liquid in the collection reservoir, in particular stirring liquid in the collection reservoir.

Liquid applied to a sheet material with the apparatus and method according to the invention may basically be any liquid and any sheet material, where liquid waste shall be reduced and a homogeneous liquid application is desired.

The apparatus and method are particularly suitable for liquids and sheet materials used in the tobacco industries.

Preferably, the liquid is a flavour, an aerosol-former, an aerosol-enhancing compound, or nicotine.

The sheet material may in particular be a sheet material used in the manufacture of products of the tobacco industries. These products may be smoking or non-smoking articles, for example heat-not-burn articles or parts of such articles. For example, the sheet material may subsequently be used in its sheet form or may be compressed, gathered or formed into a rod-shape. The sheet material may, for example, be a tobacco containing sheet such as for example tobacco cast leaf comprising homogenized tobacco material and an aerosol-former such as for example glycerine, which cast leaf is formed into a sensorial media plug. The sheet material may, for example, also be a tobacco-free cellulose-based aerosol-forming substrate comprising nicotine or flavours. The sheet material may, for example, also be a plastics foil, such as for example a polylactic acid foil that may be formed and used as a cooling plug. The sheet material may also be, for example, a tow material to be formed into a plug, for example into a hollow acetate tube or plug.

Preferably, the sheet material is a filter material, a tobacco containing material, a non-tobacco containing cellulose-based material, a wrapping material or a foil.

Preferably, the sheet material is an acetate filter tow, a polylactic acid foil, a homogenized tobacco containing sheet, a hydroxypropylmethyl cellulose and carboxy methyl cellulose containing sheet, a wrapping paper or a tipping paper.

Sheet material made of or containing homogenized tobacco material are preferably cast leaf, for example as described in WO206/050470.

Tobacco-free cellulose-based aerosol-forming substrate may, in particular, be a hydroxypropylmethyl cellulose and carboxy methyl cellulose containing sheet, as for example described in WO2022/248378.

A sheet material used in the apparatus and method according to the invention is preferably provided as continuous sheet material, such as for example a band material. However, also individual pieces of sheet material may be supplied to the apparatus.

For performing the method according to the invention and as described herein, preferably, an apparatus according to the invention and as described herein is used. Features and advantages as described relating to the apparatus are applicable also to the method and vice versa.

According to another aspect of the present invention, there is provided a shielding device for an apparatus according to the invention and as described herein. The shielding device comprises a concave shield having a central opening for accommodating a spray nozzle in the central opening. The concave shield further comprising a collection channel provided at an inner periphery of the shield and at least one drain hole arranged in the collection channel.

The collection channel may be arranged along the entire inner periphery of the shield.

The collection channel may be arranged to run circumferentially along the inner periphery of the concave shield.

Preferably, the collection channel is formed by inwardly bent peripheral sections of the shield.

The collection channel may run along the periphery of the shield, preferably along a circumference of the shield, in a tilted manner such that the shield has a lowest portion, wherein the at least one drain hole is arranged in the lowest portion.

A drain conduit may be provided at the at least one drain hole.

The collection channel may comprise more than one drain hole. A drain conduit may be provided at each of the more than one drain hole.

The concave shield may have a round circumference, for example is circular or elliptic, or may have a rectangular perimeter.

The concave shield may include a dome shape.

Preferably, the concave shield is bell-shaped.

The concave shield may comprise curved wall portions and may comprise flat wall portions.

A flat wall portion may, for example, form a top wall of the concave shield. A top wall is preferably arranged horizontally in a mounted state of the concave shield.

A flat wall portion may form a lower side wall of the concave shield.

A lower side wall of the concave shield may be arranged at an angle, for example, between 40 degree and 90 degree, wherein 90 degree corresponds to the vertical in a mounted state of the shield. Preferably, a lower side wall may be arranged, for example, at an angle between 45 degree and 90 degree, wherein 90 degree corresponds to the vertical in a mounted state of the shield.

In general, wall portions of the concave shield preferably comprise a slant angle, for example, between 4 degree and 90 degree, more preferably between 6 degree and 50 degree. In preferred embodiments of the concave shield, a majority of wall portions of the concave shield comprise a slant angle of at least 30 degree.

In embodiments of a flat concave shield, a majority of wall portions are flat and comprise a slant angle of, for example, between 5 degree and 10 degree.

The concave shield may have a maximum lateral extension, preferably a diameter between, for example, 0.10 meter and 1 meter. More preferably, the concave shield has a maximum lateral extension, preferably a diameter, between 0.15 meter and 0.7 meter, even more preferably between 0.2 meter and 0.5 meter.

The shielding device may comprise a temperature control system adapted to control a temperature of the concave shield, in particular of shield side walls, the collection channel or drain conduit(s) if provided.

The temperature control system preferably comprises a heater and a temperature sensor. The temperature control system may comprise a cooling element for cooling the concave shield.

The shielding device may comprise vibration means for vibrating at least parts of the concave shield.

Features and advantages of the shielding device have been mentioned relating to the apparatus and will not be repeated.

The term ‘nozzle’ is used to define a device part for generation of a liquid spray. The nozzle is understood to be part of a nebulizer, wherein ‘nebulizer’ generally indicates any device suitable for droplet formation for a liquid distribution. In particular, a nebulizer may be a device for liquid spray generation using, for example, air jet, atomizer, vibrating mesh, ultrasonic oscillation, for example of a piezoelectric element.

The invention is defined in the claims. However, below there is provided a non-exhaustive list of non-limiting examples. Any one or more of the features of these examples may be combined with any one or more features of another example, embodiment, or aspect described herein.

Example Ex1: An apparatus for liquid application to a sheet material, the apparatus comprising a nozzle for spraying a liquid on a sheet material arrangeable below the nozzle, and a concave shield arranged around the nozzle, wherein the concave shield comprises a collection channel provided at an inner periphery of the shield and wherein at least one drain hole is arranged in the collection channel for draining collected liquid from the collection channel.

Example Ex2: The apparatus according to example Ex1, wherein the collection channel is arranged along the entire inner periphery of the shield.

Example Ex3: The apparatus according to any one of the preceding examples, wherein the collection channel is arranged to run circumferentially along the inner periphery of the concave shield.

Example Ex4: The apparatus according to any one of the preceding examples, wherein the collection channel is formed by inwardly bent peripheral sections of the shield.

Example Ex5: The apparatus according to any one of the preceding examples, wherein the collection channel is arranged around the nozzle in a tilted manner such that the shield has a lowest portion, wherein the at least one drain hole is arranged in the lowest portion.

Example Ex6: The apparatus according to any one of the preceding examples, wherein a drain conduit is provided at the at least one drain hole.

Example Ex7: The apparatus according to any one of the preceding examples, comprising a collection reservoir arranged distant from the shield and such to accommodate liquid collected in and drained from the collection channel.

Example Ex8: The apparatus according to any one of examples Ex6 or Ex7, wherein the drain conduit runs from the at least one drain hole to the collection reservoir.

Example Ex9: The apparatus according to any one of the preceding examples, wherein the collection channel comprises more than one drain hole.

Example Ex10: The apparatus according to example Ex9, wherein a drain conduit is provided at each of the more than one drain hole.

Example Ex11: The apparatus according to example Ex10 when referring back to example Ex7, wherein the drain conduits run from the more than one drain hole to the collection reservoir. Example Ex12: The apparatus according to any one of the preceding examples, wherein the concave shield has a round circumference, for example is circular or elliptic.

Example Ex13: The apparatus according to any one of examples Ex1 to Ex11, wherein the concave shield has a rectangular perimeter.

Example Ex14: The apparatus according to any one of the preceding examples, wherein the concave shield includes a dome shape.

Example Ex15: The apparatus according to any one of the preceding examples, wherein the concave shield is bell-shaped.

Example Ex16: The apparatus according to any one of the preceding examples, wherein the concave shield comprises curved wall portions.

Example Ex17: The apparatus according to any one of the preceding examples, wherein the concave shield comprises flat wall portions.

Example Ex18: The apparatus according to example Ex17, wherein a flat wall portion forms a top wall of the concave shield.

Example Ex19: The apparatus according to example Ex18, wherein the top wall is arranged horizontally in a mounted state of the concave shield.

Example Ex20: The apparatus according to any one of examples Ex17 to Ex19, wherein a flat wall portion forms a lower side wall of the concave shield.

Example Ex21: The apparatus according to example Ex20, wherein the lower side wall of the concave shield is arranged at an angle between 40 degree and 90 degree, wherein 90 degree corresponds to the vertical in a mounted state of the shield.

Example Ex22: The apparatus according to example Ex21, wherein the lower side wall is arranged at an angle between 45 degree and 90 degree.

Example Ex23: The apparatus according to any one of the preceding examples, wherein wall portions of the concave shield comprise a slant angle between 4 degree and 90 degree, preferably between 6 degree and 50 degree, for example 7 degree or 45 degree.

Example Ex24: The apparatus according to any one of the preceding examples, wherein a majority of wall portions of the concave shield comprise a slant angle of at least 30 degree.

Example Ex25: The apparatus according to any one of the preceding examples, wherein an inside of the concave shield is continuous, preferably, continuously curved.

Example Ex26: The apparatus according to any one of the preceding examples, wherein the concave shield has a maximum lateral extension, preferably a diameter, between 0.10 meter and 1 meter.

Example Ex27: The apparatus according to any one of the preceding examples, wherein the concave shield has a maximum lateral extension, preferably a diameter, between 0.15 meter and 0.7 meter.

Example Ex28: The apparatus according to any one of the preceding examples, comprising a temperature control system adapted to control a temperature of sprayed liquid.

Example Ex29: The apparatus according to example Ex28, wherein the temperature control system is adapted to control a temperature of at least any one of concave shield, in particular collection channel, drain conduit(s) if provided and collection reservoir if provided.

Example Ex30: The apparatus according to any one of examples Ex28 to Ex29, wherein the temperature control system is adapted to control a temperature of the nozzle.

Example Ex31: The apparatus according to any one of examples Ex28 to Ex30, wherein the temperature control system comprises a heater and a temperature sensor.

Example Ex32: The apparatus according to any one of examples Ex28 to Ex31, wherein the temperature control system comprises a cooling element, preferably for cooling the concave shield.

Example Ex33: The apparatus according to any one of the preceding examples, comprising vibration means for vibrating at least parts of the concave shield.

Example Ex34: The apparatus according to any one of examples Ex7 to Ex33, wherein the collection reservoir comprises a stirring mechanism.

Example Ex35: The apparatus according to any one of the preceding examples, comprising a transport device adapted for transporting a sheet material past the nozzle with the concave shield.

Example Ex36: The apparatus according to example Ex35, wherein the transport device comprises at least one roller rotatable in a transport direction and adapted for supporting a sheet material to be transported in the transport direction and for passing the apparatus below the nozzle.

Example Ex37: The apparatus according to any one of the preceding examples, further comprising a housing covering the apparatus.

Example Ex38: A method for liquid application to a sheet material, the method comprising: providing a sheet material and a nozzle for liquid application;
transporting the sheet material past the nozzle, thereby applying liquid to the sheet material by the nozzle;
trapping liquid not applied to the sheet material with a concave shield arranged around the nozzle; letting trapped liquid accumulate and flow along inner side walls of the concave shield; collecting trapped liquid in a collection channel provided at an inner periphery of the concave shield; and
draining collected liquid from the collection channel through at least one drain hole arranged in the collection channel.

Example Ex39: The method according to example Ex38, collecting liquid along the entire inner periphery of the shield.

Example Ex40: The method according to any one of examples Ex38 to Ex39, designing the collection channel in a tilted manner to have a lowest portion and arranging the at least one drain hole in the lowest portion.

Example Ex41: The method according to any one of examples Ex37 to Ex40, further draining collected liquid through a drain conduit and into a collection reservoir.

Example Ex42: The method according to any one of examples Ex37 to Ex41, draining collected liquid from the collection channel through more than one drain hole.

Example Ex43: The method according to any one of examples Ex37 to Ex42, therein letting trapped liquid flow along continuously formed side walls of the concave shield.

Example Ex44: The method according to any one of examples Ex37 to Ex43, therein controlling a temperature of the liquid to control evaporation or crystallization of trapped or collected liquid.

Example Ex45: The method according to example Ex44, therein heating liquid trapped or collected by the concave shield, in particular heating liquid on shield side walls, in the collection channel, in a drain conduit if provided or in a collection reservoir if provided.

Example Ex46: The method according to any one of examples Ex44 to Ex45, therein cooling the concave shield, in particular side walls of the concave shield.

Example Ex47: The method according to any one of examples Ex38 to Ex46, therein vibrating the concave shield.

Example Ex48: The method according to any one of examples Ex38 to Ex47, comprising moving liquid in the collection reservoir, in particular stirring liquid in the collection reservoir.

Example Ex49: The method according to any one of examples Ex38 to Ex48, wherein the liquid is a flavour, an aerosol-former, an aerosol-enhancing compound, or nicotine.

Example Ex50: The method according to any one of examples Ex38 to Ex49, wherein the sheet material is a sheet material used in the manufacture of products of the tobacco industries. Example Ex51: The method according to any one of examples Ex38 to Ex50, wherein the sheet material is a filter material, a tobacco containing material, a non-tobacco containing cellulose-based material, a wrapping material or a foil.

Example Ex52: The method according to example Ex51, wherein the sheet material is an acetate filter tow, a polylactic acid foil, a homogenized tobacco containing sheet, a hydroxypropylmethyl cellulose and carboxy methyl cellulose containing sheet, a wrapping paper or a tipping paper.

Example Ex53: The method according to any one of examples Ex38 to Ex52, therein using an apparatus according to any one of examples Ex1 to Ex37.

Example Ex54: A shielding device for an apparatus according to any one of examples Ex1 to Ex37, the shielding device comprising a concave shield having a central opening for accommodating a spray nozzle in the central opening, the concave shield further comprising a collection channel provided at an inner periphery of the shield and at least one drain hole arranged in the collection channel.

Example Ex55: The shielding device according to example Ex54, wherein the collection channel is arranged along the entire inner periphery of the shield.

Example Ex56: The shielding device according to any one of examples Ex54 to Ex55, wherein the collection channel is arranged to run circumferentially along the inner periphery of the concave shield.

Example Ex57: The shielding device according to any one of examples Ex54 to Ex56, wherein the collection channel is formed by inwardly bent peripheral sections of the shield.

Example Ex58: The shielding device according to any one of examples Ex54 to Ex57, wherein the collection channel runs along the periphery of the shield, preferably along a circumference of the shield, in a tilted manner such that the shield has a lowest portion, wherein the at least one drain hole is arranged in the lowest portion.

Example Ex59: The shielding device according to any one of examples Ex54 to Ex58, wherein a drain conduit is provided at the at least one drain hole.

Example Ex60: The shielding device according to any one of examples Ex54 to Ex59, wherein the collection channel comprises more than one drain hole.

Example Ex61: The shielding device according to example Ex60, wherein a drain conduit is provided at each of the more than one drain hole.

Example Ex62: The shielding device according to any one of examples Ex54 to Ex61, wherein the concave shield has a round circumference, for example is circular or elliptic.

Example Ex63: The shielding device according to any one of examples Ex54 to Ex61, wherein the concave shield has a rectangular perimeter.

Example Ex64: The shielding device according to any one of examples Ex54 to Ex63, wherein the concave shield includes a dome shape.

Example Ex65: The shielding device according to any one of examples Ex54 to Ex64, wherein the concave shield is bell-shaped.

Example Ex66: The shielding device according to any one of examples Ex54 to Ex65, wherein the concave shield comprises curved wall portions.

Example Ex67: The shielding device according to any one of examples Ex54 to Ex66, wherein the concave shield comprises flat wall portions.

Example Ex68: The shielding device according to example Ex67, wherein a flat wall portion forms a top wall of the concave shield.

Example Ex69: The shielding device according to example Ex68, wherein the top wall is arranged horizontally in a mounted state of the concave shield.

Example Ex70: The shielding device according to any one of examples Ex67 to Ex69, wherein a flat wall portion forms a lower side wall of the concave shield.

Example Ex71: The shielding device according to example Ex70, wherein the lower side wall of the concave shield is arranged at an angle between 40 degree and 90 degree, wherein 90 degree corresponds to the vertical in a mounted state of the shield.

Example Ex72: The shielding device according to example Ex71, wherein the lower side wall is arranged at an angle between 45 degree and 90 degree.

Example Ex73: The shielding device according to any one of examples Ex67 to Ex72, wherein wall portions of the concave shield comprise a slant angle between 4 degree and 90 degree, preferably between 6 degree and 50 degree.

Example Ex74: The shielding device according to any one of examples Ex67 to Ex73, wherein a majority of wall portions of the concave shield comprise a slant angle of at least 30 degree.

Example Ex75: The shielding device according to any one of examples Ex67 to Ex74, wherein the concave shield has a maximum lateral extension, preferably a diameter, between 0.10 meter and 1 meter.

The shielding device according to any one of examples Ex67 to Ex75, wherein the concave shield has a maximum lateral extension, preferably a diameter, between 0.15 meter and 0.7 meter.

Example Ex76: The shielding device according to any one of examples Ex67 to Ex76, comprising a temperature control system adapted to control a temperature of the concave shield, in particular of the collection channel or drain conduit(s) if provided.

Example Ex77: The shielding device according to example Ex77, wherein the temperature control system comprises a heater and a temperature sensor.

Example Ex78: The shielding device according to any one of examples Ex77 to Ex78, wherein the temperature control system comprises a cooling element for cooling the concave shield.

Example Ex79: The shielding device according to any one of examples Ex67 to Ex79, comprising vibration means for vibrating at least parts of the concave shield.

Examples will now be further described with reference to the figures in which:

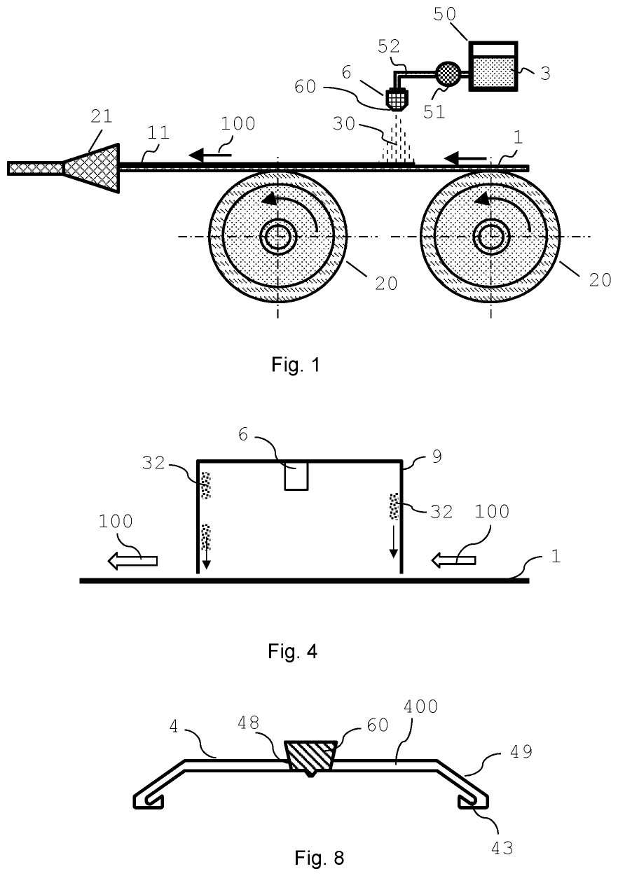

FIG. 1 shows a flavour application system;

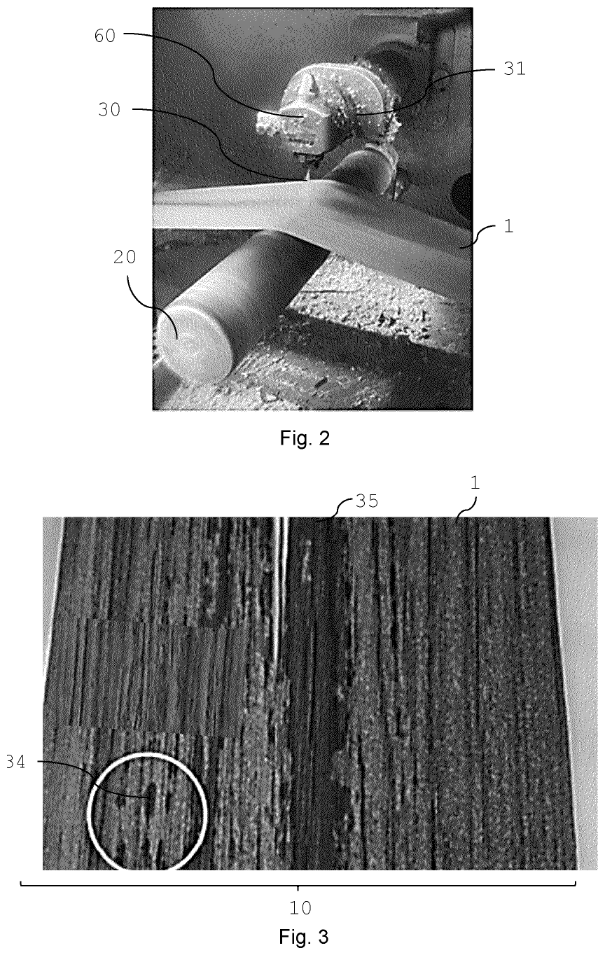

FIG. 2 shows crystallization on a liquid application system;

FIG. 3 shows issues of liquid application on a tobacco sheet;

FIG. 4 shows drop formation on a liquid application chamber;

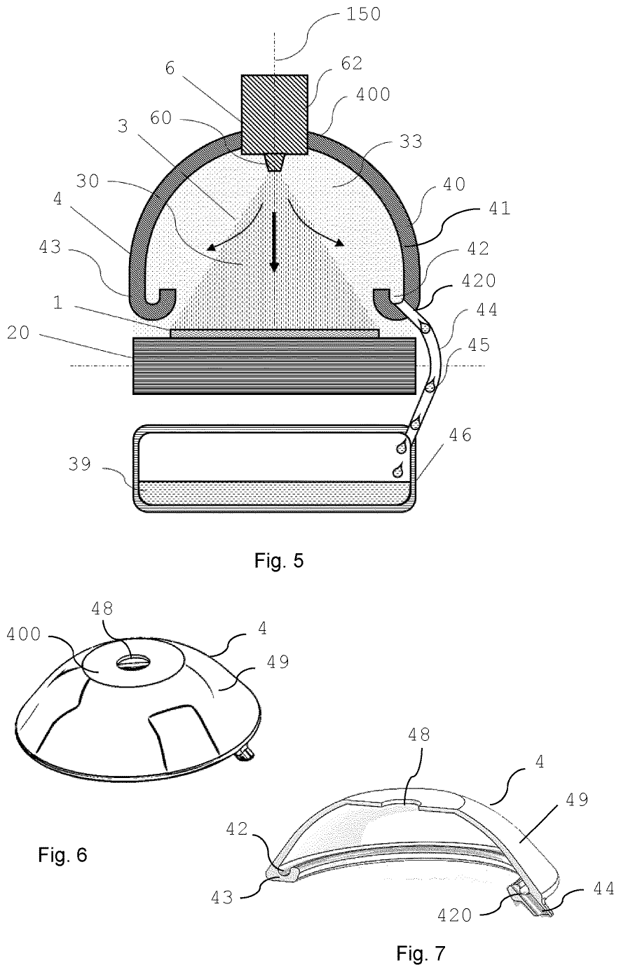

FIG. 5 shows a schematic view of an apparatus for liquid application with bell-shaped shield;

FIG. 6 shows a perspective top view of another embodiment of a concave shield;

FIG. 7 shows the shield of FIG. 6 in a perspective cross-sectional cut view;

FIG. 8 shows another embodiment of a concave shield;

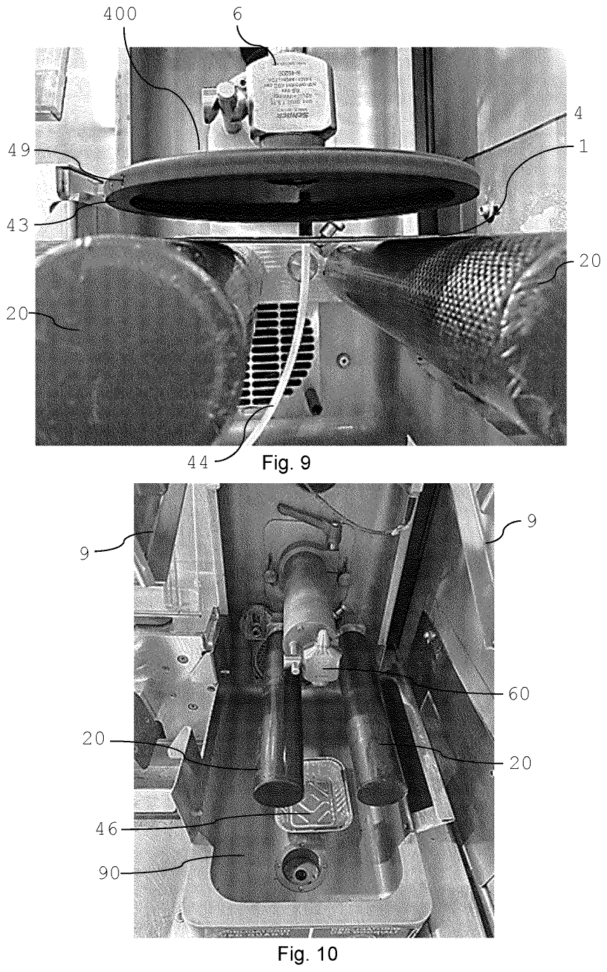

FIG. 9 shows an apparatus for liquid application with substantially flat concave shield;

FIG. 10 shows a flavour application chamber with open housing.

FIG. 1 illustrates the principle of a liquid application system on a sheet material 1, for example, flavour application to a tobacco sheet.

The continuous sheet 1, for example tobacco cast leaf, is transported via rollers 20 along a transport direction 100. The sheet 1 passes underneath a nozzle 60, where liquid 3, for example a flavour, is sprayed to the sheet 1. The sheet 1 provided with a flavour coating 11 is then guided into a funnel shaped tool 21, where the flavoured sheet 1 is compressed and formed into a continuous rod.

The liquid 3 to be applied to the sheet 1 is provided in a reservoir 50. A pump 51 drives the liquid 3 from the reservoir 50 through a tube 52 to the nozzle 60 of a nebulizer 6. By the nozzle 60 a spray 30 is created that is directed to the sheet 1. Typically, only gravitational force acts on the liquid spray 30 for the droplets of the spray 30 to be guided to the sheet 1. However, the spray 30 may also be pressurized to provide smaller droplets of liquid.

In FIG. 2 a continuous sheet 1 is guided over a roller 20 below a nozzle 60. A liquid spray 30 is provided by the nozzle 60, for example, of a nebulizer 6, spraying liquid on the sheet 1. In an example, the sheet 1 is a homogenized tobacco sheet, in particular tobacco cast leaf. In the example shown in FIG. 2, the liquid is a favour, namely menthol. Menthol is a much-favoured flavour used in the tobacco industries but has a strong tendency to crystallize.

As may be seen in FIG. 2, the sprayed liquid has crystallized on apparatus parts, here in particular on and around the nozzle 60. Crystallized liquid 31 on apparatus parts is mainly waste and lost for an application process. In addition, crystallized liquid 31 may clog the nozzle 60 leading to a reduced efficiency of the nozzle 60, to inhomogeneous flavour application results and to process interruption to perform the required maintenance. Since process interruption also means interruption of a liquid flow and static condition in the nozzle 60, even further crystallization will occur in the nozzle 60.

FIG. 3 shows a tobacco sheet 1 having a width 10 of about 17 cm that is inhomogeneously sprayed with liquid 3. In the example of FIG. 3, the liquid has been sprayed with a narrow spray jet expansion and with no or low pressure. As may be seen, more liquid is applied to the sheet 1 along a central band 35. This part of the sheet 1 had been arranged directly under the nozzle 1 when the sheet 1 was guided through a liquid application apparatus. In addition, larger drops have formed that are applied to the sheet 1 at discrete spots 34. At these spots 34 liquid concentration is too high. This may lead to inconsistent flavour release in a final product, in particular in tobacco products. It may also lead to liquid migration, for example by capillary action, to an outer wrapping paper and to ‘spotting’ of the wrapping paper.

These effects may be reduced or prevented by using nebulizers that create a wide spray and by spraying under elevated pressure.

High pressure nebulizers are preferred in liquid application as they may homogenize a distribution of liquid, since typically small droplets are created. However, small droplets are more volatile and tend to move in all directions. Thus, a number of small droplets may not be available for application to the sheet 1 but may possibly contaminate the environment.

In FIG. 4 an effect of liquid droplets spreading from a nebulizer 6 to a sheet 1 transported through an application chamber 9 is shown. The droplets also move sideways and accumulate on chamber walls. The so formed drops 32 slide down along the chamber walls (indicated by vertical arrows) and eventually fall on the sheet 1 that passes through the chamber 9 in transport direction 100. These drops 32 may also form discrete spots 34 on the sheet 1 with an enhanced amount of liquid, in particular flavour, as shown in FIG. 3.

FIG. 5 shows a schematic front cut view of an apparatus for liquid application with a concave shield 4 in the form of a bell 40 arranged around a nozzle 60.

A sheet 1, for example a homogenized tobacco sheet, is transported on roller 20 (perpendicular to the direction of the drawing place) and passes under a nebulizer 6. By the nozzle 60 of the nebulizer 6 a liquid 3, for example a flavour, is sprayed onto the sheet 1.

The bell 40 is arranged with its top part 400 at the level of the nebulizer body 62, above the nebulizer's nozzle 60. The bell 40 has a central axis 150, which may also be a rotational axis, substantially corresponding to a central axis of the spray 30 of the nozzle 60.

The top part 400 of the bell 40 is formed by downwardly bent wall portions. The walls 41 of the bell 40 are gradually stronger bent until lower wall portions are substantial flat or straight and parallel to the central axis 150 of the shield 4. These lower wall portions are arranged vertically in the mounted stated of the shield 4 as shown in FIG. 5. The shield walls 41 including the top part 400 are continuous and provide good droplet trapping, agglomeration and in particular good downwards guidance along inner side walls of accumulated liquid.

The bell 40 is arranged around the nebulizer's nozzle 60 and around the upper part of the spray 30. The bell 40 then points downward into the direction of the sheet 1 and tightly encloses the spray 30 without hindering the spray's main distribution area.

Part of the particles of the spray 30 are going toward the sheet 1 leading to the desired liquid application of the sheet 1. Other particles 33, typically more volatile ones, are drifting away from the direction of the sheet 1. These particles 33 will eventually contact the inside of the shield walls 41 and be trapped at the walls. These particles 33 will accumulate at the shield walls 41 and due to gravity, eventually slide along the shield's inner walls toward the collection channel 42 arranged at the periphery 43 or bottom of the shield 4.

The collection channel 42 is formed by inwardly and upwardly bent end regions of the shield's walls. The collection channel 42 is provided with a drain opening 420 with a drain pipe 44, for example a plastics tube, attached to the drain opening 420. The drain pipe 44 leads to a collection reservoir 46 into which flavour droplets 45, which have not reached the sheet 1 but have been trapped by the concave shield 4, are collected. The collected liquid 39 may be reused, either directly by reintroducing the collected liquid 39 into a liquid reservoir of the nebulizer 6 or after having passed a cleaning process.

In FIG. 5, the concave shield 4 is positioned above the sheet 1 such that the collection channel 42, thus the periphery of the shield 4, is arranged laterally outside of the sheet 1. For example, an outer diameter of the bell 40 is about 18 cm with a width of the sheet 1 of about 17 cm.

In addition, the shield 4 is arranged close above the sheet 1, for example at a distance between 25 cm and 40 cm, for example about 33 cm. By this, the spray 30 of the nozzle 60 is not hindered for liquid application on the sheet 1, at least not at lateral sides of the sheet 1. Additionally, most particles 33 of the liquid mist that would otherwise be drifting to the environment is collected by the shield 4.

By the shield walls 41, most volatile flavour mist is trapped, decreasing environmental, safety and security issues. In addition, trapped liquid is led to a collection channel 42, then to a collection reservoir 46, from which the collected liquid 39 may be recovered and reused, thus decreasing waste.

The collection of spread liquid droplets may also prevent the formation of large drops on chamber walls as shown and explained in FIG. 4, and by this may avoid leakage of liquid onto the passing sheet 1. In addition, longer runs are ensured before having to stop an apparatus for cleaning operation. Since crystallization of liquid, in particular flavour crystallization, inside a nozzle 60 mainly occurs during stops i.e., when there is no flow through the nozzle 60, the provision of a concave shield 4 around the nozzle 60 also reduces crystallization inside the nozzle 60.

In FIGS. 6 and 7 a circular concave shield 4, also in the form of a bell, is shown. In the perspective view of FIG. 6 a circular flat top part 400 having an opening 48 in the center of the top part 400 for accommodating a nebulizer in the opening 401 may be seen. The side walls 49 of the shield 4 are bent downwards and radially outwards and connect with the top part 400 of the shield. The lower portions of the side walls 49 direct straight radially outwards and downward such that the concave shield is more open than the bell-shaped shield as shown in the example of FIG. 5. Thus, the concave shield 4 shown in FIGS. 6 and 7 allows for a wider spread spray of liquid to apply to a sheet 1. In the cut view of FIG. 7, the inwardly bent lowest portions or most peripheral portions of the side walls 49 forming the circumferentially running collection channel 42 may be seen. A drain hole 420 is arranged in the collection channel 42. A portion of a drain pipe 44 is integrally formed with the shield 4. A drain tube may be attached to the portion of the drain pipe and lead to a collection reservoir.

The shield 4 may be attached to a nebulizer or a nozzle of a nebulizer, preferably such that the drain hole 420 is arranged at a lowest point of the shield 4. By this, liquid collected in the collection channel 42 runs in the collection channel to the drain hole 420.

The collection channel 42 may also be formed by the lowest portions of the side walls 49 in a tilted manner (tilted with respect to a plane parallel to the plane of the flat top part 400) such that the drain hole 420 is located at a lowest point in the shield. By the provision of the drain hole 420 at a lowest point of the collection channel helps to drain the liquid that has reached the collection channel 42.

In FIG. 8 a cross-sectional view of a concave shield 4 in the shape of a flat shield having flat walls only is shown.

A nozzle 60 is arranged in the opening 48 in the flat top part 400 of the shield 4. The flat side walls 49 direct radially and downwardly at an angle of about 45 degrees with respect to the flat top part 400 or to a horizontal, respectively. Preferably, the shield 4 is circular. However, the cross-section shown in FIG. 8 may also belong to a rectangular shield, wherein a longitudinal extension of the shield points perpendicular to the drawing plane.

A collection channel 43 is formed at a most peripheral position of the concave shied 4.

FIG. 9 shows a liquid application apparatus with a flat concave shield 4. The flat top part 400 of the flat concave shield 4 is arranged horizontally and the side walls 49 of the shield are flat, direct straight downward and are arranged perpendicular to the top part 400. The diameter of the flat top part 400 corresponds to the diameter of the shield 4. A drain pipe 44 is in fluid connection with a drain hole in the collection channel 43.

A continuous sheet 1 supported by two rollers 20 is arranged below the concave shield 4 and the nebulizer 6.

Such a large and flat shield 4 is preferably used with large drops formed by nebulizer 6. Large drops tend to mainly fall downwards or also sideways but will eventually fall into the direction of the sheet 1 due to gravitational force. Thus, the flat shield 4 traps the most volatile droplets only but does not hinder droplets that otherwise would have reached the sheet 1.

FIG. 10 shows a liquid application apparatus with an open chamber housing 9. In FIG. 10 the concave shield has been removed for better visibility of the individual parts of the apparatus. Two rollers 20 are arranged in parallel to each other. The nozzle 60 is arranged above the rollers 20 and in between the two rollers 20 when seen in a vertical direction. A collection reservoir 46 is arranged below the rollers 20 in a bottom part 90 of the housing 9.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1-15. (canceled)

16. An apparatus for liquid application to a sheet material, the apparatus comprising:
a nozzle configured to spray a liquid on a sheet material arrangeable below the nozzle; and
a concave shield arranged around the nozzle,
wherein the concave shield comprises a collection channel provided at an inner periphery of the shield,
wherein the collection channel is arranged to run circumferentially along the inner periphery of the concave shield, and
wherein at least one drain hole is arranged in the collection channel and configured to drain collected liquid from the collection channel.

17. The apparatus according to claim 16, wherein the collection channel is formed by inwardly bent peripheral sections of the shield.

18. The apparatus according to claim 16,
wherein the collection channel is arranged around the nozzle in a tilted manner such that the shield has a lowest portion, and
wherein the at least one drain hole is arranged in the lowest portion.

19. The apparatus according to claim 16, further comprising a collection reservoir arranged distant from the shield and such to accommodate liquid collected in and drained from the collection channel.

20. The apparatus according to claim 16, wherein the concave shield has a round circumference.

21. The apparatus according to claim 16, wherein the concave shield further comprises curved wall portions.

22. The apparatus according to claim 16, wherein the concave shield further comprises flat wall portions.

23. The apparatus according to claim 16, wherein wall portions of the concave shield comprise a slant angle between 4 degrees and 90 degrees.

24. The apparatus according to claim 16, wherein wall portions of the concave shield comprise a slant angle between 6 degrees and 50 degrees.

25. The apparatus according to claim 16, wherein a majority of wall portions of the concave shield comprise a slant angle of at least 30 degrees.

26. The apparatus according to claim 16, wherein an inside of the concave shield is continuous.

27. The apparatus according to claim 16, wherein an inside of the concave shield is continuously curved.

28. The apparatus according to claim 16, wherein the concave shield has a maximum lateral extension between 0.10 meter and 1 meter.

29. The apparatus according to claim 16, wherein the concave shield has a diameter between 0.10 meter and 1 meter.

30. The apparatus according to claim 16, further comprising a temperature control system configured to control a temperature of sprayed liquid.

31. A method for liquid application to a sheet material, the method comprising:
providing a sheet material and a nozzle for liquid application;
transporting the sheet material past the nozzle, thereby applying liquid to the sheet material by the nozzle;
trapping liquid not applied to the sheet material with a concave shield arranged around the nozzle;
letting trapped liquid accumulate and flow along inner side walls of the concave shield;
collecting trapped liquid in a collection channel provided at an inner periphery of the concave shield along the entire inner periphery of the shield; and
draining collected liquid from the collection channel through at least one drain hole arranged in the collection channel.

32. The method according to claim 31, wherein the liquid is a flavour, an aerosol-former, an aerosol-enhancing compound, or nicotine.

33. A shielding device for an apparatus according to claim 16, the shielding device comprising a concave shield having a central opening configured to accommodate a spray nozzle in the central opening, the concave shield further comprising a collection channel provided at an inner periphery of the shield, wherein the collection channel is arranged to run circumferentially along the inner periphery of the concave shield, and at least one drain hole arranged in the collection channel.
